(19) United States
(12) Patent Application Publication
(10) Pub. No.: US 2008/0303805 A1
(43) Pub. Date: Dec. 11, 2008

(54) Digital picture frame and method of displaying digital image data on a display unit of the digital picture frame

(76) Inventors: Chih-Ta Chien, Taipei (TW); Wei-Hsiang Liao, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/892,435

(22) Filed: Aug. 23, 2007

(30) Foreign Application Priority Data
Jun. 7, 2007 (TW) 096120512

(51) Int. Cl. G09G 5/00

(52) U.S. Cl. 345/204

(57) ABSTRACT

A digital picture frame includes a display unit connected movably to a base unit, and a driving unit operable so as to drive the display unit to move relative to the base unit between a lengthwise position and a widthwise position. A controller determines whether digital image data acquired from a memory unit is that of a portrait or a landscape, determines whether the display unit is currently at the lengthwise position or the widthwise position, controls the driving unit such that the display unit is moved to the lengthwise position when the digital image data is that of a portrait and to the widthwise position when the digital image data is that of a landscape, and subsequently controls the display unit to display the digital image data thereon. A method of displaying the image data on the display unit is also disclosed.

### CROSS-REFERENCE TO RELATED APPLICATION

This application claims priority of Taiwanese Application No. 096120512, filed on Jun. 7, 2007.

### BACKGROUND OF THE INVENTION

1. Field of the Invention

The invention relates to a digital picture frame, more particularly to a method of displaying digital image data on a display unit of a digital picture frame, and to a digital picture image that implements the method.

2. Description of the Related Art

With the growing popularity of digital image capturing devices, such as digital cameras, images captured by a digital image capturing device can be stored in a storage medium in the form of an image file for storage purposes. Thus, a digital picture frame has been proposed to display digital image data thereon.

Digital image data presented as a digital picture can be that of a portrait or a landscape. The digital image data has an image length and an image width. When the image length is greater than the image width, the digital image data is that of a portrait. On the other hand, when the image width is greater than the image length, the digital image data is that of a landscape.

Referring to FIGS. 1 and 2, a conventional digital picture frame 1 is shown to include a display 11 that has a display screen 110. When the conventional digital picture frame 1 is at a widthwise position, the display screen 110 has a width, and a length shorter than the width, as shown in FIG. 1. When the conventional digital picture frame 1 is a lengthwise position, the display screen 110 has a length, and a width shorter than the length, as shown in FIG. 2.

However, when the conventional digital picture frame 1 is at the widthwise position and when the digital image data being displayed is that of a portrait, to avoid image distortion attributed to full-screen display, there are opposite lateral blank areas in the display screen 110, as shown in FIG. 1. On the other hand, when the conventional digital picture frame 1 is at the lengthwise position and when the digital image data being displayed is that of a landscape, to avoid image distortion attributed to full-screen display, there are opposite upper and lower blank areas in the display screen 110, as shown in FIG. 2. The presence of the blank areas in the display screen 110 results in unsatisfactory presentation of the digital image data. While it is possible to manually adjust the conventional digital image frame 1 to an appropriate position corresponding to the digital image data being displayed, such manual adjustment is inconvenient for users.

### SUMMARY OF THE INVENTION

Therefore, the object of the present invention is to provide a digital picture frame and a method of displaying digital image data on a display unit of the digital picture frame that can overcome the aforesaid drawbacks of the prior art.

According to one aspect of the present invention, there is provided a method of displaying digital image data on a display unit of a digital picture frame. The digital picture frame has a base unit connected to the display unit, a memory unit for storing the digital image data, and a driving unit operable so as to drive the display unit to move relative to the base unit between a lengthwise position and a widthwise position. The method comprises the steps of:

a) determining whether the digital image data is that of a portrait or a landscape;

b) determining whether the display unit is currently at the lengthwise position or the widthwise position;

c) based on results determined in steps a)and b), displaying the digital image data on the display unit when the digital image data is that of a portrait while the display unit is at the lengthwise position or when the digital image data is that of a landscape while the display unit is at the widthwise position; and

d) based on the results determined in steps a) and b), driving the display unit to move from a current one of the lengthwise position and the widthwise position to the other one of the lengthwise position and the widthwise position when the digital image data is that of a portrait while the display unit is currently at the widthwise position or when the digital image data is that of a landscape while the display unit is currently at the lengthwise position, and subsequently displaying the digital image data on the display unit.

According to another aspect of the present invention, a digital picture frame comprises:

a base unit;

a display unit connected movably to the base unit;

a memory unit for storing digital image data;

a driving unit operable so as to drive the display unit to move relative to the base unit between a lengthwise position and a widthwise position; and

a controller connected electrically to the display unit, the driving unit and the memory unit, the controller determining whether the digital image data acquired from the memory unit is that of a portrait or a landscape, determining whether the display unit is currently at the lengthwise position or the widthwise position, controlling the driving unit such that the display unit is moved to the lengthwise position when the digital image data is that of a portrait and to the widthwise position when the digital image data is that of a landscape, and subsequently controlling the display unit to display the digital image data thereon.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic view illustrating digital image data of a portrait displayed on a conventional digital picture frame that is at a widthwise position;

FIG. 2 is a schematic view illustrating digital image data of a landscape displayed on the conventional digital picture frame that is at a lengthwise position;

FIG. 3 is a schematic circuit block diagram illustrating the preferred embodiment of a digital picture image according to the present invention;

FIG. 4 is a schematic side view showing the preferred embodiment;

FIG. 5 is a schematic view showing the preferred embodiment when a display unit is at a lengthwise position;

FIG. 6 is a schematic view showing the preferred embodiment when the display unit is at a widthwise position; and

FIG. 7 is a flow chart illustrating how digital image data is displayed on the display unit according to the method of the preferred embodiment.

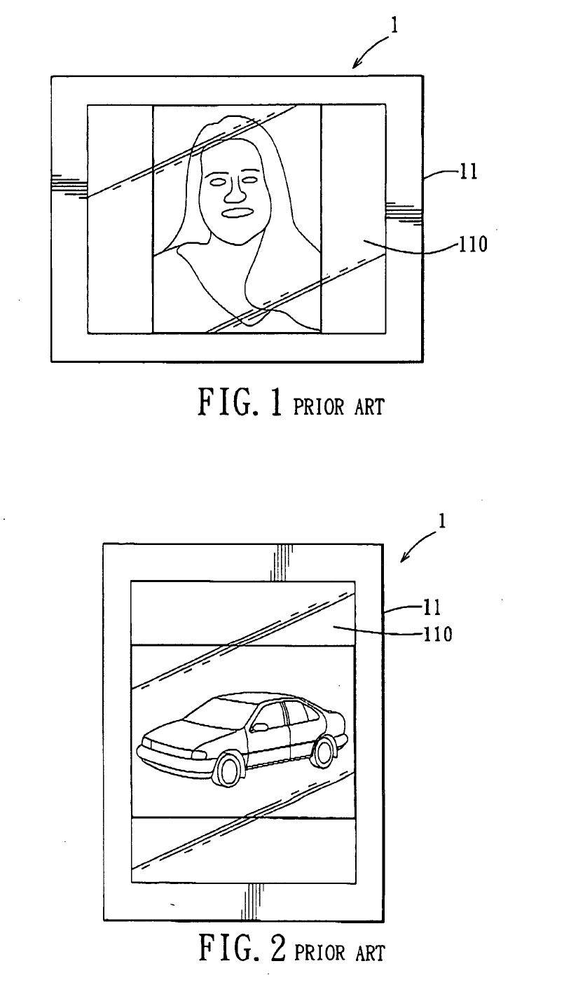

### DETAILED DESCRIPTION OF THE PREFERRED EMBODIMENT

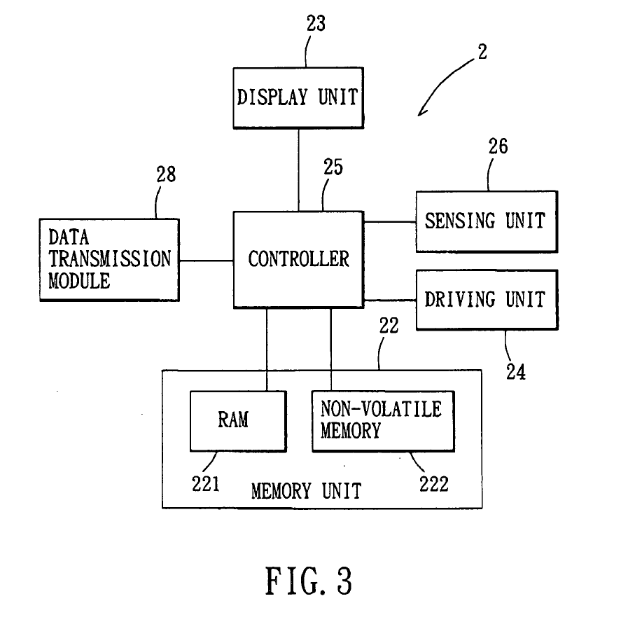

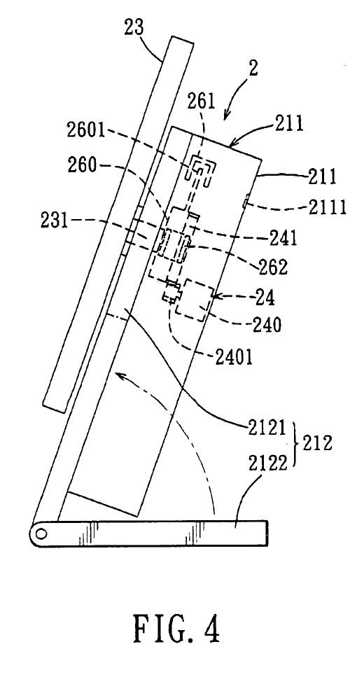

Referring to FIGS. 3 and 4, the preferred embodiment of a digital picture frame 2 according to the present invention is shown to include a base unit 21, a display unit 23, a memory unit 22, a driving unit 24, a controller 25, and a sensing unit 26.

The base unit 21 is adapted to be placed on a supporting surface (not shown) or to be hung on a wall surface (not shown). In this embodiment, the base unit 21 includes a supporting frame 212 and a hollow main body 211. As shown in FIG. 4, the supporting frame 212 has a first frame body 2121, and a second frame body 2122 connected pivotally to a bottom side of the first frame body 2121 such that the second frame body 2122 is pivotable relative to the first frame body 2121 so as to move between a supporting portion, where an angle is formed between the first and second frame bodies 2121, 2122, and a non-supporting position, where the first and second frame bodies 2121, 2122 are parallel and close to each other. The main body 211 is mounted on a rear side of the first frame body 2121, and has a rear side formed with an engaging groove 2111. Thus, when the base unit 21 is to be placed on the supporting surface, the second frame body 2122 is at the supporting position. On the other hand, when the base unit 21 is to be hung on the wall surface, the second frame body 2122 is disposed at the non-supporting position and an engaging groove 2111 in the main body 211 can be used to engage a hanger (not shown) on the wall surface.

The display unit 23 is connected movably to the base unit 21. In this embodiment, the display unit 23 is disposed on a front side of the first frame body 2121 of the supporting frame 212 of the base unit 21, and has a connecting rod 231 passing through the first frame body 2121 and connected pivotally to the main body 211.

In this embodiment, the memory unit 22 is disposed in the base unit 21, and includes a random access memory (RAM) 221 for temporarily storing data, and a non-volatile memory 222 for storing digital image data. The digital image data has an image length and an image width. The digital image data is that of a portrait when the image length is greater than the image width. The digital image data is that of a landscape when the image width is greater than the image length. In order to obtain an enhanced data access speed, the RAM 221 can be asynchronous dynamic random access memory (SDRAM), and the non-volatile memory 222 can be a flash memory. In other embodiments, the memory unit 22 can be disposed in the display unit 23.

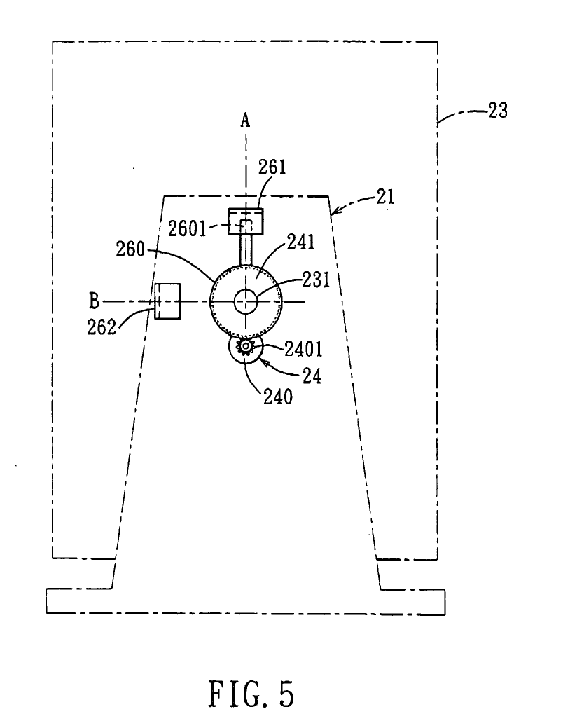

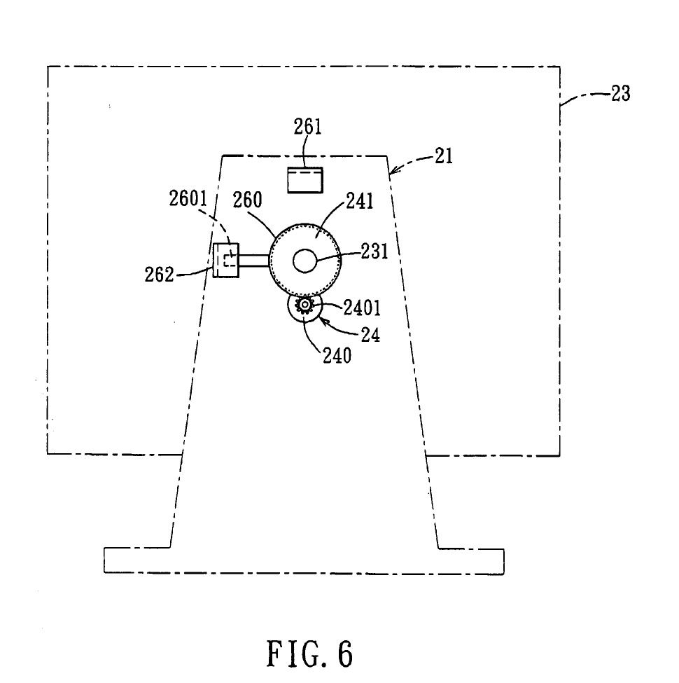

The driving unit 24 is operable so as to drive the display unit 23 to move relative to the base unit 21 between a lengthwise position, where the display unit 23 has a length larger than a width thereof (see FIG. 5), and a widthwise position, where the display unit 23 has a width larger than a length thereof (see FIG. 6). In this embodiment, the driving unit 24 is disposed in the main body 211 of the base unit 21, and includes a motor 240, such as a stepping motor or a DC motor, for driving the connecting rod 231 to rotate by means of a driven gear 241 meshing with a motor shaft 2401 of the motor 240 and connected coaxially to the connecting rod 231 such that the connecting rod 231 co-rotates with the driven gear 241.

The controller 25 is connected electrically to the display unit 23, the driving unit 24 and the memory unit 22. The controller 25 is programmed to determine whether the digital image data acquired from the non-volatile memory 222 of the memory unit 22 is that of a portrait or a landscape, to determine whether the display unit 23 is currently at the lengthwise position or the widthwise position, to control the driving unit 24 such that the display unit 23 is moved to the lengthwise position when the digital image data is that of a portrait and to the widthwise position when the digital image data is that of a landscape, and to subsequently control the display unit 23 to display the digital image data thereon. In this embodiment, the controller 25 is a media processor that is disposed in the base unit 21. In other embodiments, the controller 25 can be disposed in the display unit 23.

It is noted that the controller 25 controls the motor 240 of the driving unit 24 for driving the connecting rod 231 to rotate relative to the base unit 21 to move the display unit 23 from one of the lengthwise position and the widthwise position to the other one of the lengthwise position and the widthwise position and from the other one of the lengthwise position and the widthwise position to said one of the lengthwise position and the widthwise position in two opposite directions, respectively, such as clockwise and counterclockwise directions, thereby minimizing the time and power consumption required for transition of the display unit 23 between the lengthwise position and the widthwise position.

Referring further to FIGS. 5 and 6, the sensing unit 26 is disposed in the base unit 21, and is connected electrically to the controller 25 for detecting whether the display unit 23 is at the lengthwise position or the widthwise position. In this embodiment, the sensing unit 26 includes a driver member 260, and first and second position sensors 261, 262 corresponding respectively to the lengthwise position and the widthwise position. The first and second position sensors 261, 262 are preferably infrared sensors, and are mounted in the main body 211 of the base unit 21 (see FIG. 4), wherein a first extension line (A) passing through the first position sensor 261 and the connecting rod 231 is perpendicular to a second extension line (B) passing through the second position sensor 262 and the connecting rod 231, as shown in FIG. 5. Each of the first and second position sensors 261, 262 outputs a sensing signal to the controller 25 upon detecting that the display unit 23 is at a corresponding one of the lengthwise position and the widthwise position. The driven member 260 is connected coaxially to the connecting rod 231 5 such that the driven member 260 is co-rotatable with the connecting rod 231. The driven member 260 has a free end 2601 sensed by one of the first and second position sensors 261, 262 when the display unit 23 is moved to one of the lengthwise position and the widthwise position such that said one of the first and second position sensors 261, 262 outputs the sensing signal to the controller 25, thereby enabling the controller 25 to determine the current position of the display unit 23.

More specifically, as shown in FIG. 5, when the display unit 23 is moved to the lengthwise position, the free end 2601 of the driven member 260 is sensed by the first position sensor 261, which outputs the sensing signal to the controller 25, thereby informing the controller 25 that the display unit 23 is currently at the lengthwise position. On the other hand, as shown in FIG. 6, when the display unit 23 is moved to the widthwise position, the free end 2601 of the driven member 260 is sensed by the second position sensor 262, which outputs the sensing signal to the controller 25, thereby informing the controller 26 that the display unit 23 is currently at the widthwise position.

In other embodiments, the sensing unit 26 may include a single position sensor to sense the free end 2601 of the driven member 260 when the display unit 23 is moved to one of the lengthwise position and the widthwise position. However, in such a configuration, it is required to initialize the display unit 23 to said one of the lengthwise position and the widthwise position by controlling the driving unit 24 to rotate the display unit 23 until the position sensor senses the free end 2601 of the driven member 260. Thereafter, rotation of the display unit 23 is performed based on whether the digital image data is that of a portrait or a landscape.

In this embodiment, the digital picture frame 2 further includes a data transmission module 28, such as a card reader or a USB connector, connected electrically to the controller 25 for transmitting external data to the controller 25. Since the feature of the invention does not reside in the configuration of the data transmission module 28, which is conventional, details of the same are omitted herein for the sake of brevity.

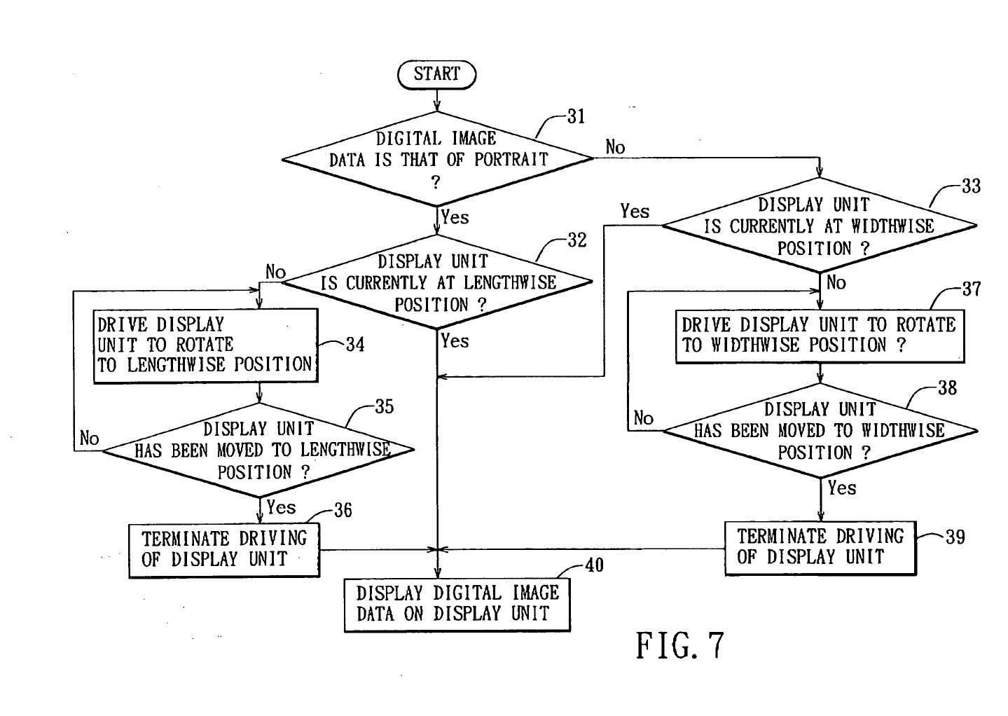

In this embodiment, a program to be executed by the controller 25 when displaying digital image data on the display unit 23 is stored in the non-volatile memory 222. Referring to FIG. 7, there is shown a flow chart illustrating how digital image data is displayed on the display unit 23 according to the method of the preferred embodiment of this invention.

In step 31, the controller 25 is configured to determine whether the digital image data, which is acquired from the non-volatile memory 222 of the memory unit 22, is that of a portrait. If affirmative, the flow goes to step 32. Otherwise (i.e., the digital image data is that of a landscape), the flow goes to step 33. In step 32, the controller 25 is configured to determine whether the display unit 23 is currently at the lengthwise position based on the sensing signal received from the sensing unit 26. If affirmative, the flow proceeds to step 40. Otherwise (i.e., the display unit 23 is currently at the widthwise position), the flow goes to step 34. In step 34, the controller 25 is configured to control the driving unit 24 to drive the display unit 23 to rotate in the clockwise direction from the widthwise position to the lengthwise position, and the flow goes to step 35. In step 35, the controller 25 is configured to judge whether the display unit 23 has been moved to the lengthwise position based on detection by the sensing unit 26. If negative, the flow goes back to step 34. Otherwise, the flow proceeds to step 36. In step 36, the controller 25 is configured to control the driving unit 24 to terminate driving of the display unit 23, and the flow proceeds to step 40 in step 40, the controller 25 is configured to display the digital image data on the display unit 23. In step 33, the controller 25 is configured to determine whether the display unit 23 is currently at the widthwise position. If affirmative, the flow proceeds to step 40. Otherwise (i.e., the display unit 23 is currently at the lengthwise position), the flow goes to step 37. In step 37, the controller 25 is configured to control the driving unit 24 to drive the display unit 23 to rotate in the counterclockwise direction from the lengthwise position to the widthwise position, and the flow goes to step 38. In step 38, the controller 25 is configured to judge whether the display unit 23 has been moved to the widthwise position based on detection by the sensing unit 26. If negative, the flow goes back to step 37. Otherwise, the flow proceeds to step 39. In step 39, the controller 25 is configured to control the driving unit 24 to terminate driving of the display unit 23, and the flow proceeds to step 40.

In sum, due to the presence of the controller 25, the driving unit 24 and the sensing unit 26, prior to displaying the digital image data, the display unit 23 can be automatically moved to an appropriate position, i.e., the lengthwise position or the widthwise position, depending on whether the digital image data is that of a portrait or a landscape, thereby resulting in convenience during use and ensuring proper presentation of the digital image data.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. A method of displaying digital image data on a display unit of a digital picture frame, the digital picture frame having a base unit connected to the display unit, a memory unit for storing the digital image data, and a driving unit operable so as to drive the display unit to move relative to the base unit between a lengthwise position and a widthwise position, said method comprising the steps of:
a) determining whether the digital image data is that of a portrait or a landscape;
b) determining whether the display unit is currently at the lengthwise position or the widthwise position;
c) based on results determined in steps a)and b), displaying the digital image data on the display unit when the digital image data is that of a portrait while the display unit is at the lengthwise position or when the digital image data is that of a landscape while the display unit is at the widthwise position; and
d) based on the results determined in steps a) and b), driving the display unit to move from a current one of the lengthwise position and the widthwise position to the other one of the lengthwise position and the widthwise position when the digital image data is that of a portrait while the display unit is currently at the widthwise position or when the digital image data is that of a landscape while the display unit is currently at the lengthwise position, and subsequently displaying the digital image data on the display unit.

2. The method as claimed in claim 1, wherein, in step a), the digital image data has an image length and an image width, the digital image data being that of a portrait when the image length is greater than the image width, the digital image data being that of a landscape when the image width is greater than the image length.

3. The method as claimed in claim 1, wherein step d) includes the sub-steps of:
d-1) when the digital image data is that of a portrait while the display unit is currently at the widthwise position or when the digital image data is that of a landscape while the display unit is currently at the lengthwise position, driving the display unit to move from the current one of the lengthwise position and the widthwise position to the other one of the lengthwise position and the widthwise position;
d-2) detecting whether the display unit has been moved to the other one of the lengthwise position and the widthwise position:
d-3) terminating driving of the display unit upon detecting that the display unit has been moved to the other one of the lengthwise position and the widthwise position; and
d-4) displaying the digital image data on the display unit.

4. The method as claimed in claim 1, wherein, in step d), the display unit is driven to rotate relative to the base unit from the current one of the lengthwise position and the widthwise position to the other one of the lengthwise position and the widthwise position.

5. The method as claimed in claim 4, wherein rotation of the display unit relative to the base unit from one of the lengthwise position and the widthwise position to the other one of the lengthwise position and the widthwise position and from the other one of the lengthwise position and the widthwise position to said one of the lengthwise position and the widthwise position are performed in two opposite directions.

6. The method as claimed in claim 3, wherein detection of the position of the display unit is conducted using first and second position sensors, each of the first and second position sensors corresponding to a respective one of the lengthwise position and the widthwise position.

7. A digital picture frame comprising:
a base unit;
a display unit connected movably to said base unit;
a memory unit for storing digital image data;
a driving unit operable so as to drive said display unit to move relative to said base unit between a lengthwise position and a widthwise position; and
a controller connected electrically to said display unit, said driving unit and said memory unit, said controller determining whether the digital image data acquired from said memory unit is that of a portrait or a landscape, determining whether said display unit is currently at the lengthwise position or the widthwise position, controlling said driving unit such that said display unit is moved to the lengthwise position when the digital image data is that of a portrait and to the widthwise position when the digital image data is that of a landscape, and subsequently controlling said display unit to display the digital image data thereon.

8. The digital picture frame as claimed in claim 7, wherein the digital image data has an image length and an image width, the digital image data being that of a portrait when the image length is greater than the image width, the digital image data being that of a landscape when the image width is greater than the image length.

9. The digital picture frame as claimed in claim 7, wherein:
said display unit has a connecting rod connected pivotally to said base unit; and
said driving unit is disposed in said base unit, and includes a motor for driving said connecting rod to rotate.

10. The digital picture frame as claimed in claim 9, wherein said controller controls said motor for driving said connecting rod to rotate relative to said base unit to move said display unit from one of the lengthwise position and the widthwise position to the other one of the lengthwise position and the widthwise position and from the other one of the lengthwise position and the widthwise position to said one of the lengthwise position and the widthwise position in two opposite directions, respectively.

11. The digital picture frame as claimed in claim 7, further comprising a sensing unit disposed in said base unit and connected electrically to said controller for detecting whether said display unit is at the lengthwise position or the widthwise position.

12. The digital picture frame as claimed in claim 11, wherein said sensing unit includes first and second position sensors, each of said first and second position sensors outputting a sensing signal to said controller upon detecting that said display unit is at a corresponding one of the lengthwise position and the widthwise position.

13. The digital picture frame as claimed in claim 12, wherein a first extension line passing through said first position sensor and said connecting rod is perpendicular to a second extension line passing through said second position sensor and said connecting rod.

14. The digital picture frame as claimed in claim 13, wherein said first and second position sensors are infrared sensors, said sensing unit further including a driven member connected coaxially to said connecting rod such that said driven member is co-rotatable with said connecting rod, said driven member having a free end sensed by one of said first and second position sensors when said display unit is moved to one of the lengthwise position and the widthwise position.

15. The digital picture frame as claimed in claim 7, wherein said controller is a media controller.
